(19) United States
(12) Patent Application Publication
(10) Pub. No.: US 2023/0280188 A1
(43) Pub. Date: Sep. 7, 2023

(54) SYSTEM AND METHOD FOR FACILITATING REAL-TIME SHARING OF LOCATION OF POINTS OF INTEREST

(71) Applicant: Henderson Carter, Fort Lee, NJ (US)

(72) Inventor: Henderson Carter, Fort Lee, NJ (US)

(21) Appl. No.: 17/685,015

(22) Filed: Mar. 2, 2022

(51) Int. Cl. G01C 21/34; G01C 21/36; G06Q 30/02; H04W 4/02; H04W 4/40

(52) U.S. Cl. CPC G01C 21/3476; G01C 21/3685; G01C 21/3602; G01C 21/3647; G01C 21/362; G06Q 30/0207; H04W 4/025; H04W 4/40

(57) ABSTRACT

A method for facilitating real-time sharing of location over the internet of available parking and other points of interest among a plurality of users having a plurality of user computing devices currently located at or arriving at a target area via a server connected to the internet. A computer system to improve, simplify, and facilitate real-time sharing of location over the internet of available parking and other points of interest among a plurality of users having a plurality of user computing devices currently located at or arriving at a target area via a server connected to the internet.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The instant disclosure generally relates to navigation and/or vehicle guidance systems for traffic and parking control purposes and systems in which vehicles are guided by instructions to the vehicles and/or their operators. Specifically, the instant disclosure relates to navigation systems by which indication is given to a vehicle operator as to the location of points of interest through a variety of means of wireless electronic communication among a plurality of devices which may include distant and local networks, mobile devices, vehicle-installed devices, networked sensors, and/or combinations of the like.

### Description of the Related Art

In most major cities and even among some town centers in smaller towns and villages, there often exists a shortage of parking for the number of vehicles wishing to park, especially during peak hours for any given area. For instance, a business center of a city may experience parking shortages during working hours, the restaurant or shopping center may experience parking shortages during evenings, “lunch rushes”, or weekends. As a result, some or many drivers wishing to park in such an area during such a peak time may experience difficulty and frustration when attempting to drive, park, exit their vehicle, and arrive at their intended destination in time for what may be an important deadline. Some vehicle drivers and their occupants may be forced to travel amongst parking lots and city streets in search for unoccupied parking, often balancing the urgent need to park their vehicle with the expense related to a given spot, the distance from their intended destination, and the convenience of accessing the destination from an available parking spot, among various other potential considerations. Driving or “cruising” through an area, only for the necessity of finding parking, when done by a sufficient number of drivers in their vehicles, may only further frustrate an already frustrating situation by causing an increase in traffic on a given parking lot or roadway. During peak periods of occupancy, drivers in search of parking may account for a substantial portion of those occupying a city street or town center.

Therefore, on city streets and in town centers, parking spaces often become limited commodities. Each space may be of value to residents while they are at their home, merchants while they desire access to parking for their patrons during business hours, the same patrons to those merchants' retail stores, tourists, and visitors to government buildings, among various others. In order to better allocate the parking space as a commodity, local governments and private parking owners often establish policies and procedures around who may park where and at what time. Furthermore, individual spaces or access to lots may be sold or leased much like real estate or a commodity, where a parking fee is paid for a given period of access to parking in an area or spot or a parking spot is sold outright for one person's, organization's or the like's access. In these cases, machines may be installed to either govern access or meter time available to the driver while parked. Other measures to implement these policies may include lot attendants, parking meter attendants, and towing companies. Even with these measures in place, the marketplace of parking spaces as commodities may have inefficiencies which cause few spaces to remain in a city or town center, despite drivers who may be seeking a space for their vehicles to park and their willingness to pay for that privilege. This may further frustrate the scenario outlined above, when at peak times many drivers travel multiple times passed various locations in search of parking, further congesting traffic in that area.

Primitive attempts to resolve these frustrations have included visible signage or lot attendants directing drivers to vehicle parking within busy city centers. These signs, still present on many roadways, usually include the direction of parking, a universal symbol for parking that usually consists of the letter “P” within a circle, and possibly the distance from the sign or the flat or hourly fee to park in a given area. Improvements to these systems may include interchangeable placards which lot attendants may manually change to indicate whether or how many open spots exist generally in a given area or lot, light matrixes or other electronic visual displays to indicate the same, or lot attendants using visual or audible cues to direct drivers to available areas for parking. The latter improvement can often be witnessed at major events where abnormally large numbers of travelers may be expected to arrive at a given time and place, such as a concert or sporting event. These systems may be extremely helpful for both those familiar and not familiar to an area as they are generally obvious and recognizable to drivers, especially those in search of places to park their vehicle. However, various shortfalls exist in these solutions. They include, but are not limited to the expenses related to signs, labor, placards, digital or electronic signage, and maintenance as well as they often do not provide real-time availability of the existence of free parking spaces.

With the advent of in-vehicle navigation assistant devices and, more recently, mobile devices like smartphones capable of determining real-time geolocation, having increased processing capabilities, and capable of wireless communication, many solutions for vehicle navigation have offered, in addition to their navigation services, services to indicate the geolocation of areas which parking may be available. These systems often display public and/or private parking areas designated by a “pin” that may or may not include the universal parking symbol. A driver using one of these systems may be able to view parking areas relative to their current location or a destination on a map that updates their own real-time location. This allows a driver to more easily navigate to convenient areas which may feature available parking, and may even provide visual and/or audio guidance in a turn-by-turn manner. Some such applications may even allow its users to pay for an allotted time in a specified spot or area within the application, avoiding the need to operate a parking meter. These systems may be extremely helpful to those drivers, both those who are familiar and those who are not familiar with an area as they can orient a driver and indicate in two-dimensional space where they may look for parking that may be available. In combination with more primitive technologies, such as physical signs, they may provide a driver with a sufficient combination of tools by which they may seek out available parking. However, even with this combination of systems and tools, drivers may be left cross-referencing a number of systems to verify if parking indeed does exist at a time and place where parking may exist. Therefore, there is a need for drivers for a method to obtain real-time information about available parking via a system to facilitate the sharing of real-time information about available parking.

An additional deficiency with the available systems to locate parking, even in combinations, is the lack of information or the lack of real-time information about the availability of parking in a given area. Since keeping such an updated database or system for continually monitoring parking availability, especially over large areas or globally, may require constant monitoring, supervision, surveillance, sensors, and various types of human involvement such as actively monitoring and communicating about available parking areas, and doing so only when parking becomes scarce may require disparate human and technological resources in a given time and place, few systems, even in combination, may provide adequate and reliable information about where drivers may seek out and obtain a space to park their vehicle. Even if such a system or combination of systems were to exist, multiple drivers being notified of the same spot or a driver not employing such a system finding a spot after another driver has been notified but has yet to reach the spot, may lead a driver through traffic to a space only for he or she to find it has since become occupied. Additionally, these applications may be limited to or at least exclusively designed for drivers. This limits the potential pool of individuals who may voluntarily update such a proposed system with current information, thereby decreasing its accuracy and value.

Real estate tools for real estate agents and those wishing to buy/sell properties often enable the finding and marketing available properties, but these tools are generally text based and include minimal photos provided in a linear result list sorted by price. To access more information about a property, the agent, buyer, or other person performing a search must ‘drill down’ through a series of web pages, clicking several times, spawning new web pages for viewing maps, school district, tax, and other information. More often than not, buyers, sellers, real estate agents, and the public, generally, shop for homes using a combination of web-based tools and driving to locate, view, inspect, and determine whether to purchase a particular property. However, even advanced applications for modern real estate shoppers, such as ZILLOW® and TRULIA®, often lack robust navigational tools. This often leaves users of these apps to shop in two methods simultaneously: online, via an app, and physically. And while those users using those apps may have available to them the ability to view properties based on a current location, they cannot “plot” their route, access a property, and navigate from one property to another without leaving the app and opening another map purpose-built for navigation. Additionally, listing properties often involves complicated systems which require credentialed access in order to list a property. This often leaves unrepresented buyers with limited means to market their homes to the public, or to those shopping for real estate.

The instant disclosure is designed to address at least some aspects of the problems discussed above. The system and method for facilitating real-time sharing of location of a point of interest described herein may be designed to replace or work alongside these common methods of seeking out and locating available parking or properties for sale. Indeed, in order to facilitate such a method, such a system may rely in part or solely on information provided by its users so as to avoid the resources and costs associated with monitoring the availability of parking and cataloging the like. By using a system and method for sharing real-time information about parking and real estate listings, drivers and non-driving users may help overcome many of the limitations of the systems and methods described above.

### SUMMARY

Briefly described, in a possibly preferred embodiment, the present disclosure overcomes the above-mentioned disadvantages and meets the recognized need for such a system and method by utilizing information provided by a plurality of end users, namely drivers and non-driving users, and cataloguing that information alongside relevant information such as time-of-day, geolocation, pricing information, the like and combinations thereof as it or they may relate to a point of interest (e.g., parking spot or real estate listing). Such a plurality of users may be encouraged to, through a variety of means, share real-time information with other users about the availability of parking or a home for sale located near them at any point on the planet. When a user shares this real-time information about parking or a real estate listing, a subset of other users of such a service may be notified of the availability of parking based on a number of factors. These may include, but are not limited to, their geographic proximity to the user sharing the information, their relationship, whether virtual or in real life, with the user sharing information, their membership of a group either within or external to the service, their status within the subscription and/or incentive structure of the service, whether the user who may potentially receive the information about parking availability has in the past been the provider of such information, the like, and combinations thereof. The ease by which an individual user may communicate or share this information to or with other users may dictate a user's willingness to voluntarily communicate or share this information, thereby increasing the value of such a service to all users. Furthermore, the frequency, convenience, and probability of receiving such information may increase a user's willingness to “pay-it-forward” by using such a service in the future to voluntarily communicate and share information to and with other users. Finally, a variety of incentives may exist to encourage users to furnish this information to other users, thus may dramatically increase a user's likelihood to engage in a pattern of behavior of seeking, finding, and notifying a service of available parking or properties available for purchase for others.

Broadly described, one aspect of such a system and method may include a plurality of computing devices connected to a network, such as the internet. These devices may include servers, personal computing devices such as laptops and desktops, mobile computing devices such as smartphones and tablets, personal navigation or GPS units, the like and combinations thereof. These devices each may serve a variety of functions within the disclosed system and method. For instance, a server may store and communicate information about the various points of interest as well as store information about and/or provided by the system's and method's users, maintaining an active database of the same. One or more servers may also host an application or service which may process information and be capable of connecting to a network to broadcast information to users connected to the network via a cloud service. User devices such as mobile devices may store a mobile application and/or be capable of connecting and interacting with the one or more servers via the network. These mobile devices may also feature a GPS capability and a camera allowing for the sharing of information about where a point of interest may be located, where the user may be located, and what the surroundings may look like with other users of the disclosed system and method.

By deploying and enlisting such a combination of computing devices within the above plurality of computing devices, a community of individuals may practice the disclosed system and method to achieve results such as being notified that a point of interest may be available at or near their current location. This may be achieved through a variety of means such as push notifications to a user mobile device from an application server over a network. A user with a mobile device capable of navigating through map and/or turn-by-turn guidance applications may only wish to be notified of a point of interest when they are at or approaching their designated destination. In such a case, the disclosed system and method may be adapted to allow integration into such a mobile application or be interfaced in such a way to only allow notification about a point of interest (e.g., a parking spot) when the user has reached a pre-determined perimeter from his or her destination.

One benefit of the disclosed system and method may be alerting drivers at, near, approaching, travelling to, or on a drive to an intended destination of the availability of parking at or near said destination or target area. Additionally, a benefit may be alerting drivers at, near, approaching, travelling to, or on a drive to an intended destination the location of nearby properties available or listed for purchase/sale. As discussed above, many navigation applications on mobile devices provide indicators of where parking might be found by indicating parking areas, usually with a universal sign understood to stand for parking, the letter “P” within a circle. However, these applications fail to notify their users with additional, if any, information about the parking spot availability or other information about parking spots within the parking areas. In a potentially preferred embodiment of the disclosed system and method, users of a mobile application having a connection to other devices using the disclosed system and method will be notified through a variety of means covered in greater detail below of parking spots within parking areas at or near their entered destination prior to their arrival. Similarly, many real estate shopping apps may provide a map having listings to various properties available for purchase, but they neither allow a user to engage with navigational interactive features nor do they offer users the ability to list properties without having first been credentialed, usually via a professional organization for real estate professionals. Additionally, users may, in another potentially preferred embodiment, be offered the ability to reserve such a spot from other users who may be occupying currently the spot, but may no longer need it upon the requesting user's arrival at the destination spot.

Another benefit of the disclosed system and method may be allowing both driving and non-driving users of the disclosed system and method to communicate about parking and other points of interest. Currently, few, if any, mobile applications for driving and parking would be suitable for members of the non-driving public. This may be due to mobile applications lacking features and incentives sufficient for non-drivers to either pay, subscribe to, or even download such an application. Some applications may even limit capabilities of the application to driving, for instance, by only providing driving directions and lacking pedestrian or mass transit turn-by-turn directions. By providing incentives and features for non-driving users, an application of the disclosed system and method may entice such non-driving users, as well as those not in the market for a new home, to use the application to alert driving users to parking availability. By way of example and not limitation, these capabilities and incentives may include but are not limited to providing pedestrian and mass transit navigation features, instituting a social point system to receive virtual rewards such as badges, stickers, and the like, integrating with customer loyalty programs to offer discounts to patrons of stores when they alert drivers to parking near said stores, offering an easy-to-use “spot-a-spot” feature where someone simply walking by a desirable spot may easily click, snap a photo and pin a spot on a map, the like and/or combinations thereof.

A related benefit of the disclosed system and method may be gathering a greater amount of data about real-time information with respect to available parking and homes for sale than may otherwise be practical or possible without the system and method's disclosure. Various systems and methods as described herein may influence, incentivize, or otherwise cause users to share information about real-time parking information when they would not have without the aid and assistance of systems and methods of the disclosure. Due to the ever-evolving nature of the availability of parking and the real estate market, having a large volume of data about real-time parking information and receiving said information on a continuous basis is critical to maintaining its real-time benefits. Features of select embodiments of the disclosed system and method which may greater incentivize the voluntary sharing of real-time parking information by a plurality of users of the disclosed system and method, thereby achieving a greater accuracy to said users regarding parking availability in a specified area.

In select embodiments of the disclosed system and method, the end user interface of an implementation of the disclosed system and method may be integrated into existing systems and devices for vehicle navigation in combination with merchant loyalty, paid subscription or social incentive systems. A driver, or even a non-driver, may be incentivized to share relevant parking information or information about a real estate listing through a variety of means. These incentives may operate by awarding discounts, points toward vouchers, social credit points, discounts or points toward a paid subscription level of an application or service of the disclosed system and method, the like, and/or combinations thereof. So, for example, even a non-driving user who may otherwise be a pedestrian with no need to find parking locations or a person who is not in the market to purchase a property, by using an application and/or service may receive a discount, which may be for a participating merchant having a high-demand parking area for its patrons, for alerting those with this need through an application or service of the disclosed system and method. Those skilled in the art may recognize an unresolved need for merchants to be able to share with its patrons the availability of parking near their store, and their willingness to provide loyalty incentives to other patrons for sharing such information voluntarily. Those having ordinary skill in the art may also recognize an unresolved need for listing agents and home sellers to more broadly market properties for sale for users which may not immediately in the market to purchase a property. Similarly, by using interfaces and integrations discussed below, patrons may automatically receive these types of incentives through systems and methods of the disclosure which seek to limit the amount of human involvement needed to collect this data.

In an optional embodiment of the disclosed system and method, a user of the disclosed system and method may integrate into a variety of credentialed user networks including but not limited to social networks, customer loyalty and rewards programs, payment processing and credit card customer networks, university and education enrollment management systems, private or secret club membership programs, employee networks, transportation program networks such as rail and bus systems, volunteer membership networks, political party registration, fraternal organizations, professional organizations for real estate agents, the like and/or combinations thereof. In such an embodiment, a user alerting a system and method for facilitating real-time sharing of location of available parking may be prompted or otherwise allowed to choose among a variety of organizations or networks which they possess credentials for and may be integrated into their installed version of the disclosed application of the system and method. For instance, a customer arriving at a popular destination to shop at their favorite store may be notified by another customer leaving the same store if both share membership in the store's customer loyalty program via a notification through the disclosed system and method. This may be accomplished by a user prompt, automatic triage based on a user or automatic priority or preference indication, or through any other means by which a user or a system may prioritize who among a larger group may first receive a notification about a parking space vacancy or a home listed for sale nearby.

In select applications of the disclosed system and method, the user devices within the system may connect, through a variety of means, with other devices to give indication as to whether the user is walking, driving, has parked, is exiting a parking space, or making some other action to the device of, the application on a device of, or other devices, applications and systems within the disclosed system and method. For instance, a user entering and engaging their vehicle may have thereon their user device applications and/or systems to automatically connect to their vehicle's onboard handsfree phone, wireless music, or other system for integrating device features into onboard vehicle systems. During such an event, an application of the disclosed system and method installed on said user's device may take an action based on such an event. A chain of events may then take place under the assumption that the user is no longer parked and will begin exiting his or her parking spot, thereby making it available to other users. In a situation where a user may be actively shopping for a home, the systems and methods of the disclosure herein may similarly interoperate with onboard vehicle systems and a user device to enable or activate onboard vehicle turn-by-turn directions, engage Bluetooth connectivity, interact with smarthome features of a listed property, the like and/or combinations thereof. In combinations with systems and devices within the user device, such as geolocation sensors, accelerometers, compasses, etc., applications, devices, and systems of the disclosed system and method may further verify the behavior of the driver so as to prevent erroneous information from entering its available point of interest database. Once it is confirmed, or during the confirmation process, other users of the disclosed system and method may receive notifications as according to the description provided herein.

These and other features of the system and method for facilitating real-time sharing of location of available parking will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a block diagram of a computer system of the present disclosure;

FIG. 2 is a block diagram of a communications system implemented by the computer system in FIG. 1;

FIG. 3 is a drawing of an exemplary building's parking area wherein various occupied and unoccupied parking spots exist among drivers and their vehicles;

FIG. 4a is a drawing of an exemplary user interface for navigating and locating or designating available parking spots;

FIG. 4b is a drawing of an exemplary user interface for tagging an available parking spot to enable other users to locate it;

FIG. 5 is a flowchart of the initial stages of the disclosed method; and

FIG. 6 is a flowchart of the final stages of the disclosed method;

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

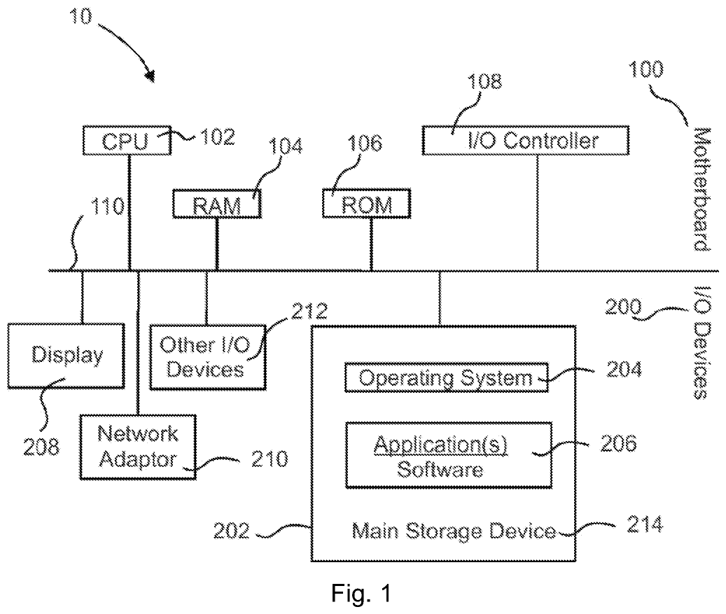

In describing the exemplary embodiments of the present disclosure, as illustrated in FIGS. 1-6, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

In order to understand the present disclosure certain variables need to be defined.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object-oriented programming languages, and other conventional programming language may be utilized without departing from the spirit and intent of the present disclosure.

Referring now to FIG. 1, there is illustrated a block diagram of a computer system 10 that provides a suitable environment for implementing embodiments of the present disclosure. The computer architecture shown in FIG. 1 is divided into two parts—motherboard 100 and the input/output (I/O) devices 200. Motherboard 100 preferably includes subsystems or processor to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 202, such as main storage device 214 for storing operating system 204 and instructions or application program(s) 206, and display 208 for visual output, and other I/O devices 212 (e.g. a geolocation sensor) as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Many other devices or subsystems or other I/O devices 212 may be connected in a similar manner, including but not limited to, devices such as a geolocation/GPS sensor, microphone, speakers, camera, flash drive, CD-ROM player, DVD player, printer, main storage device 214, such as hard drive, and/or modem each connected via an I/O adapter. Also, although preferred, it is not necessary for all of the devices shown in FIG. 1 to be present to practice the present disclosure, as discussed below. Furthermore, the devices and subsystems may be interconnected in different configurations from that shown in FIG. 1, or may be based on optical or gate arrays, or some combination of these elements that is capable of responding to and executing instructions or operations. The operation of a computer system such as that shown in FIG. 1 is readily known in the art and is not discussed in further detail in this application, so as not to overcomplicate the present discussion.

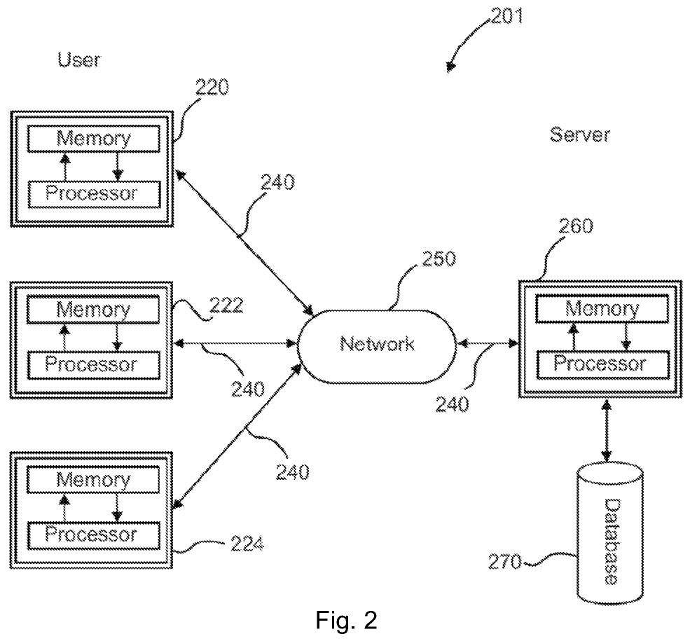

Referring now to FIG. 2, there is illustrated a diagram depicting an exemplary communication system 201 in which concepts consistent with the present disclosure may be implemented. Examples of each element within the communication system 201 of FIG. 2 are broadly described above with respect to FIG. 1. In particular, the server system 260 and user system 220 have attributes similar to computer system 10 of FIG. 1 and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random-access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

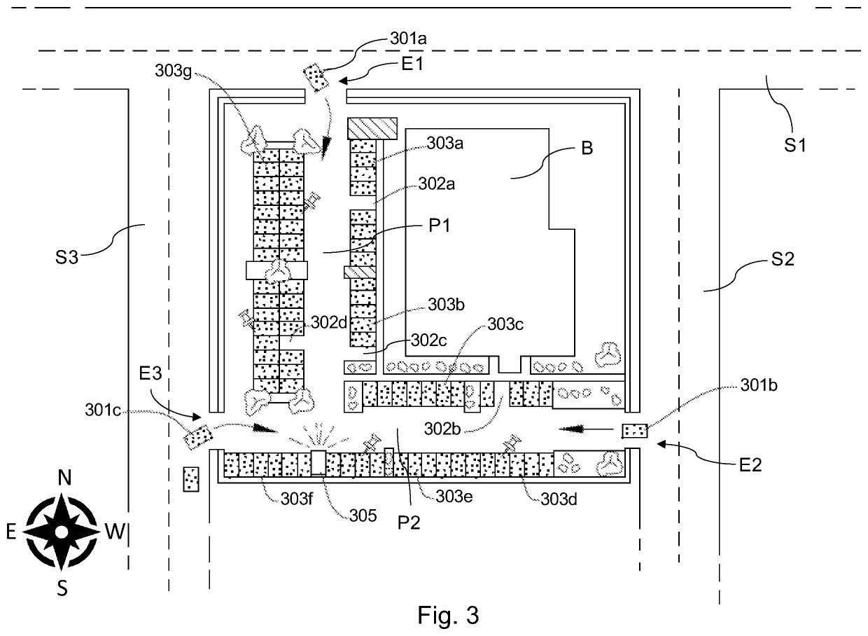

Communication system 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, print and/or view multidimensional digital master image(s) 303 (see FIG. 3). Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, print and/or view multidimensional digital master image(s) 303. The communications link 240 may include, for example, a wired, wireless, cable, optical or satellite communication system or other pathways.

It is contemplated herein that RAM 104, main storage device 214, and database 270 may be referred to herein as storage device(s) or memory device(s).

Referring again now to FIGS. 1-6, by way of example, and not limitation, therein is illustrated various example components and features that may be present in the disclosed system and method for facilitating real-time sharing of location of available parking. As will be appreciated by one skilled in the art, a critical aspect of facilitating real-time sharing of location of available parking may be first loading parking location data and other related data onto a database 270 into various arrangements for communication, analysis, and sharing among a set of users and/or user devices connecting via communication system 201. Database 270 may be referred to as or may refer to a data store, a user store, a user database or parking database herein. Subscriber, user, driver, and customer as well as parking, parking spots, parking areas, parking decks, and parking facilities may be used interchangeably. Although user and parking information and data may be contained on database 270, the disclosure is not so limited, the disclosed method and system may be used on a variety of data types, and may contain transactional data and information pertaining to or regarding subscribers, customers, clients, and/or a plurality of individuals and/or human beings, whether living or dead, or physical or non-physical constituents of matter including, but not limited to, automobiles, bicycles, scooters, motorcycles, and other motorized or non-motorized methods of transportation and vehicles, the like, and/or combinations thereof. Furthermore, business, building, government facility, tourist attraction, special event, and enterprise may be used interchangeably. Although parking and drivers and the data each may possess and/or desire to communicate are used herein to describe the disclosed system and method, the disclosed system and method may be useful to many types of applications including, but not limited to, the availability of any scarce or in-demand resource or quasi-resource such as groceries, retail items, commodities, natural resources, wild animals or plants, physical or virtual objects, recyclable goods and/or refuse, services, the like, and/or combinations thereof.

Referring now to FIG. 3, therein is illustrated a drawing of an exemplary building's parking area, or a target area where a plurality of drivers may wish to park, wherein various occupied and unoccupied parking spots exist among drivers and their vehicles. At the focus of the illustration is building B surrounded to the north, the east and the west by northern street S1, eastern street S2, and western street S3, respectively. Also illustrated are three entrances/exits to the parking area near building B: a northern exit E1, an eastern exit E2, and a western exit E3. Eastern exit E2 is directly connected to western exit E3 by second driving area P2 which is connected to norther exit E1 by first driving area P1. Along each side of first driving area P1 and second driving area P2 are illustrated a series of parking spaces, six indicated occupied spaces 303a-f and four unoccupied spaces 302a-d. Another space is illustrated with a vehicle exiting its space 305 and a north parking vehicle 301a, an east parking vehicle 301b, and a west parking vehicle 301c entering through the northern exit E1, the eastern exit E2, and the western exit E3, respectively. As will be described in greater detail below, each of the north parking vehicle 301a, the east parking vehicle 301b, and the west parking vehicle 301c may have installed thereon a mobile device or navigational equipment in the possession of a driver of each vehicle an application of the disclosed system and method in order to receive information about available parking surrounding building B. Additionally, others in the area may have similar or the same applications, such as a driver in the vehicle exiting its space 305, pedestrians, those inside building B, the like or combinations thereof. One skilled in the art would recognize that building B and all those spaces and objects in its surround may have discrete geolocations capable of being reduced, via a computing device (computer system 10) having a sensor (other I/O devices 212), a processor (CPU 102), and a non-transitory computer readable medium (main storage device 214). These computing devices may come in a variety of types, each having a specific configuration, and may include, but are not limited to, personal computers, standalone GPS navigation units, smart phones, tablet computers, the like and/or combinations thereof. With the inclusion of a network adaptor 210 having wireless capability, such a computing device may have the capability of sharing this information about the computing device position with at least one other device or network. With the further inclusion of a camera connected as one of the other I/O devices 212, the computing device may provide additional information which may not be possible with geolocation alone, such as obstacles or obstructions, size of available parking spot/area, proximity to sidewalks and/or entrances, weather information, the like and/or combinations thereof. Finally, such a computing device carried by a user in the surround area of Building B may likely include a display 208.

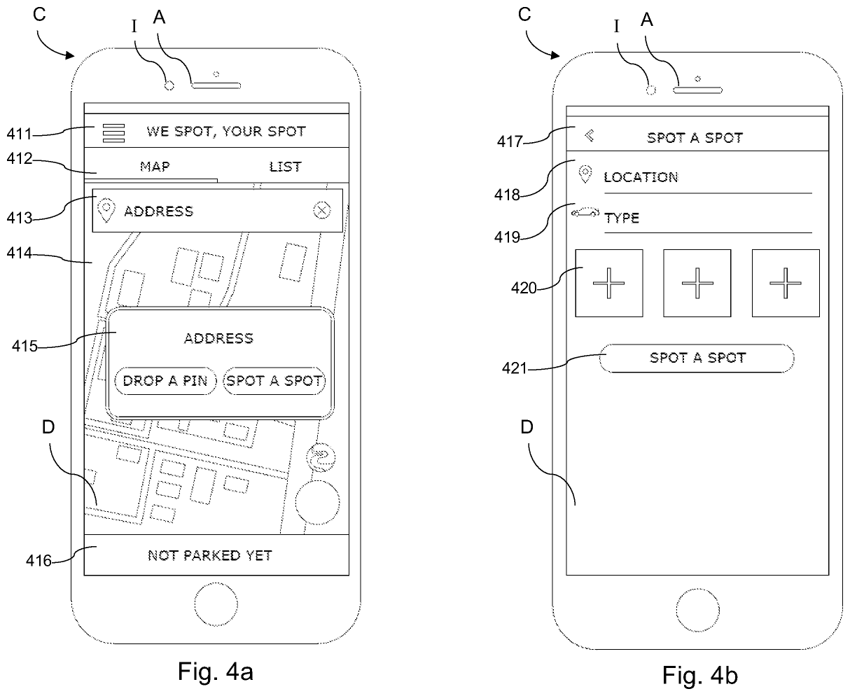

Referring now to FIG. 4a, therein is illustrated a drawing of an exemplary user interface for navigating and locating or designating available parking spots. The exemplary user interface may appear on a display D of a computing device such as a mobile smartphone C. Mobile smartphone C may contain various features, components, devices, and systems described in more detail in FIG. 1 and interact with other computing devices via systems described in FIG. 2 in order to accomplish the intended results as displayed in FIG. 4a on display D and having the qualities and benefits described below. Other important components of mobile smartphone C may include audio input/output A and camera or image sensor I. There may exist further features important to the disclosed system and method, such as a rear facing camera (not shown) and GPS sensor (described above). Beginning at the top, an important interactive feature of the disclosed system and method may be a virtual menu button and bar 411. This bar may serve to navigate such features of the disclosed system and method such as entering user credentials, signing out, searching for destinations, the like and combinations thereof. Virtual menu button and bar 411 may appear persistently on display D during operation of an application of the disclosed system and method on a user device mobile smart phone C, or it may disappear when, for instance, scrolling through a virtual map 414 as described below. Next, map and list toggle 412 may be an important user feature. Map and list toggle may function to switch between a virtual map 414 showing pins or other representation of available points of interest and/or parking locations and a list of the same ranked by convenience and/or proximity to a user having mobile smartphone C. As discussed below, parking in proximity of a building, point of interest, or target area may be removed from a map or list based upon users within a network's actions. Address virtual button 413 may be activated by a user to bring up address option window 415. Address virtual button 413 may function by obtaining a user's location or by a user navigating or travelling on virtual map 414 and centering on a point of interest or available parking spot. When address virtual button 413 is activated, a user prompt in address option window 415 asking the user whether they would like to, by way of example and not limitation, “Drop a Pin”, “Spot a Spot”, or “List a Home”. By selecting one or more options, the example user interface shown in FIG. 4b and covered in more detail below. It is contemplated herein that a user prompt in address option window 415, or any features within the exemplary user interface may be accessible by both driving and non-driving users of the disclosed system and method. Finally, status indicator bar 416 may provide a user of a visual indication as to the status of their account within a system and method of the disclosure and may further function, for instance, for manual user updating of this status (i.e. by tapping this bar a user may change his or her status from “Not Parked Yet” to “Parked,” “Parking,” “Looking for Parking,” or “Leaving Soon”). Such manual user updating action may be achieved through a variety of methods of interactivity known by those skilled in the art, for instance, a long press or pop-up window.

Referring now to FIG. 4b, therein is illustrated a drawing of an exemplary user interface for tagging an available parking spot to enable other users to locate it. The exemplary user interface may appear on a display D of a computing device such as a mobile smartphone C. Mobile smartphone C may contain various features, components, devices, and systems described in more detail in FIG. 1 and interact with other computing devices via systems described in FIG. 2 in order to accomplish the intended results as displayed in FIG. 4a on display D and having the qualities and benefits described below. Other important components of mobile smartphone C may include audio input/output A and camera or image sensor I. There may exist further features important to the disclosed system and method, such as a rear facing camera (not shown) and GPS sensor (described above). Beginning at the top, an important interactive feature of the disclosed system and method may be a navigation bar 417. In addition to taking a user back to the previous screen as displayed in FIG. 4a, this bar may function to orient a user to the feature they selected on address option window 415. Location bar 418 may be located beneath navigation bar 417 and may either display or allow for the user entry of a user location or an available parking location. Vehicle or parking spot type bar 419 may exist beneath location bar 418 and may allow the user to input, select or otherwise communicate the size of their vehicle or the size of a parking spot. One or more image upload buttons 420 may be located directly beneath vehicle or parking spot type bar 419 and may function to activate the camera functionality that may exist on mobile smartphone C. Finally, there may exist completion button 421 which may serve to activate a chain of events that can cause all user input and information about the user's location to be shared with other devices on a network of the systems and methods of the disclosure.

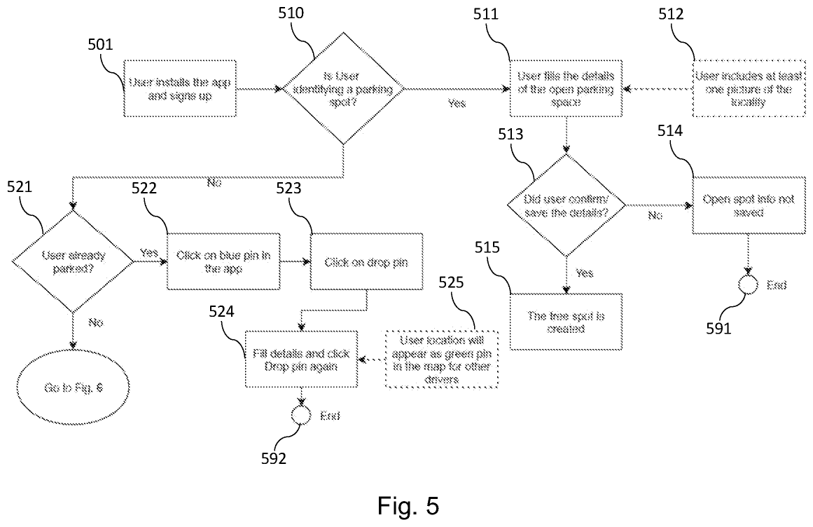

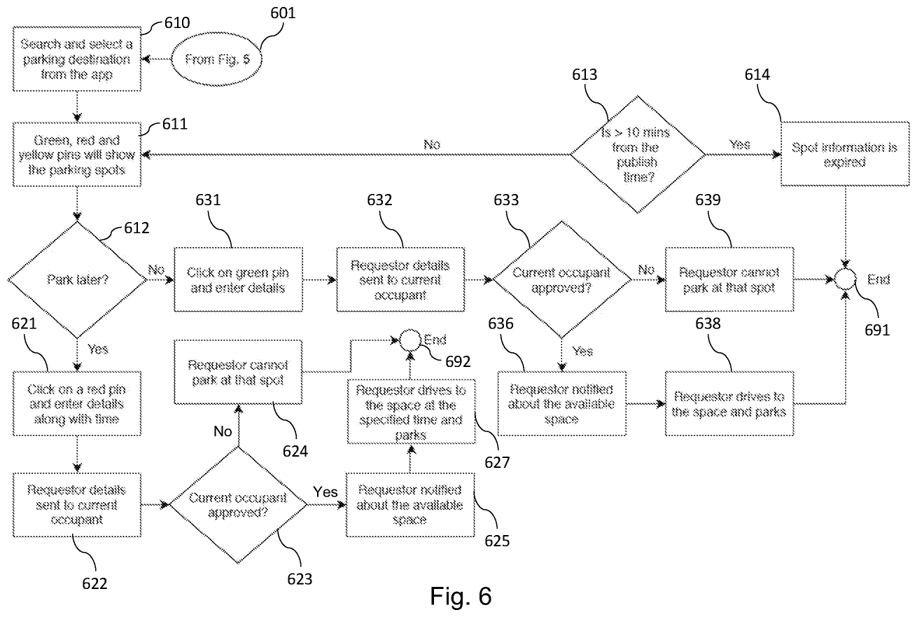

Referring now to FIG. 5, therein is illustrated a flowchart of some steps which may occur during the initial stages of the disclosed method. All steps within the disclosed method may occur on any number of or in combination of many of the devices described above. Beginning at step 501, a user may install an application having the features, components, and systems of the disclosed system and method on a user device having the qualities, components and features described above, and further having the ability of connecting to and transmitting data from a user device to a server via a connection. At step 510 a user may be prompted via the user device as to whether he or she is identifying a parking spot or not via a graphical user interface as described above. If the user is identifying a parking spot, at step 511 the user may be prompted to enter details about the parking spot, or a parking spot information in relation to the parking spot, which may include a vehicle size information, a parking spot cost information, and a geolocation metadata, and at step 512 optionally be invited to provide one or more photographs, photos, or photographic information of said parking spot. Each information set may also be assembled on a database as vehicle size data, parking cost data, geolocation data, and photographic data, respectively. At step 513 the user may have the option to confirm or save the details entered at step 511 and step 512, in which case such information may be packaged as data and transmitted to a server within the system or network of the disclosed system and method for storage on a non-transitory computer readable medium at step 515. Such information may be compiled and stored on a database as a master parking data, having information about all parking spots disclosed during the implementation and use of a system of the disclosure. Should a user decide not to save the parking details, no information would be transmitted at step 514 and the process would end at step 591. If the user is not identifying a parking spot at step 510, a determination may be made as to whether the user is already parked may be made at step 521. If a user is not already parked, the steps of the method of the disclosure is further explored in FIG. 6. If a user is already parked, a user may have available the ability to select a pin of a specific color, which may be blue, at step 522. When a user selects a pin, they may be prompted at step 523 as to whether they would like to drop a pin, so as to communicate to other users a change in the availability or otherwise update information on record regarding the spot in which they are parked. One option may be that they fill in details to update information about the spot at step 524 or they change the color of the pin at step 525 so as to reflect a change in availability of the spot. Once this is complete, the user session may end at step 592 when the user information input is communicated to systems or devices within the disclosed system and method. If information about the parking spot is already contained as an entry within a server of the disclosed system and method, the new or updated information about the spot may replace or update said entry. If information about the parking spot is not already contained as an entry within a server of the disclosed system and method, said server may create an entry for the parking spot. This may occur by first, at a primary stage, evaluating whether such an entry exists and then, at a secondary stage, if no entry exists creating one, and if an entry exists either updating, modifying, or replacing the entry. Other steps within the method and possible user entered or automatically gathered information may be present within the steps of this method and may further continue at step 601 of FIG. 6.

Continuing on from FIG. 5 and referring now to FIG. 6, therein is illustrated is a flowchart some steps which may occur during the final stages of the disclosed method. All steps within the disclosed method may occur on any number of or in combination of many of the devices described above. Beginning at step 601 from step 521 in FIG. 5 where a user has indicated that they are not already parked and following to step 610, a user is given a variety of options to search and select a destination where they may wish to find parking at or nearby. These may be presented in a variety of ways, some of which are covered in greater detail above in FIGS. 4a and 4b. If a user has searched a destination address or panned and scanned through a map to find their destination, they may be presented with a user interface showing a map of the surrounding area at step 611. On such a map, the availability of destinations may appear as color coded pins, such as, by way of example and not limitation, green for available or vehicle available to move, red for unavailable currently but with a vehicle parked by an application user, and yellow for potentially available. Depending on the estimated time from a destination or based on other factors, a user may either be prompted as to when they would like to park or the application may determine a user's time from a destination at step 612. If a user is parking now, that user may select, for instance, a green pin and enter details about, for instance, their vehicle at step 631. If a green pin were to represent, as described above, another application user who may be currently parked in the location or by another application user who has indicated they may have knowledge about the availability of the space, that user may be sent by devices on the network of the disclosed system and method a notification about a user's request to occupy that spot at step 632 which they may either approve or deny at step 633. If the currently occupying application user does not approve, the user may be notified as such at step 639 and this aspect of the session may end at step 691, and the user may go back to begin again earlier in the method, for instance at step 631 by selecting another pin. If at step 633 a currently occupying application user does approve, the requesting user may be notified that the space is or will be available at step 636 and may then drive to and begin occupying the space at step 638, ending at step 691 where, for instance, based on the user's geolocation and additional information entered by the user the devices and systems on the network of the disclosed system and method may make changes to or save data related to said information. If at step 612 the user instead selected that they will be parking later they may, for instance, at step 621 select a red pin which could indicate that the space is currently occupied by a user but may not be in the near or distant future. At this step 621 a user may be given the opportunity to provide details as to when they expect to park in this spot or this information may be automatically calculated and/or estimated based on an estimated time of arrival. By selecting a red pin at step 621, a user action may cause a chain of events at step 622 which may notify another user who may be occupying a spot related to said red pin. This notification at step 622 may include information about the expected time of arrival of the user, in addition to other details and information about the user and his or her vehicle. Having received this information, at step 624 the user who may be occupying a spot related to said red pin may then be asked to approve or deny a request from the user wishing to park in their space. If, based on the information they receive, they do not wish to allow the user wishing to park the ability to occupy the space in question, at step 624 that user may be notified as such, ending the process at step 692, and the user may go back to begin again earlier in the method, for instance at step 621 by selecting another pin. If, based on the information they receive at step 623, they do wish to allow the user wishing to park the ability to occupy the space in question, at step 625 that requesting user may be notified about the availability of the space and it may be reserved for that user within the systems and methods of the disclosure at step 625, the requesting user may then at step 627 navigate to and park in the spot corresponding to the selected pin, thereby ending at step 692 where, for instance, based on the user's geolocation and additional information entered by the user the devices and systems on the network of the disclosed system and method may make changes to or save data related to said information. At all times during the method disclosed in FIG. 5-6, a time-out may occur based upon the time since an available spot was indicated, for example at step 613 where after 10 minutes a spot indicated as available, whether or not reserved by another user is automatically changed to a color indicating that the spot is no longer available. This may be adjusted depending on a number of factors, including by way of example and not limitation, the average time a spot in that target area remains open on average based upon previous data. If more than the set amount of time elapses at step 613, the information about the spot may expire at step 614 and the session may end at step 691. As may be readily recognizable to those skilled in the art, similar processes may be utilized for additional points of interest other than parking, such as a home location. The steps and systems of the disclosed system and method may be utilized for such points of interest to achieve the result of broadcasting or marketing the point of interest to those users of the disclosed system and method.

In select embodiments, various device features may be integrated to avoid the need for a user to manually enter or select information. These may include, by way of example and not limitation, integration with systems and devices which may connect to a user device having installed thereon an application of the disclosed system and method. For instance, user devices within the system may connect, through a variety of means, with other devices to give indication as to whether the user is walking, driving, has parked, is exiting a parking space, or making some other action to the device of, the application on a device of, or other devices, applications and systems within the disclosed system and method. A user entering and engaging their vehicle may have thereon their user device applications and/or systems to automatically connect or pair to their vehicle's onboard handsfree phone, wireless music, or other system for integrating device features into onboard vehicle systems. During such an event, an application of the disclosed system and method installed on said user's device may take an action based on such an event, such as indicating to devices on the network of the disclosed system and method that a space previously marked as occupied at step 638 or at step 627 may change to an indication that the spot is no longer occupied at step 636 or step 514. A chain of events may then take place under the assumption that the user is no longer parked and will begin exiting his or her parking spot, thereby making it available to other users. During the loss of connection from such a paired set of devices, the opposite may occur under the assumption that the user has parked and exited his or her vehicle. In combinations with systems and devices within the user device, such as geolocation sensors, accelerometers, compasses, etc., applications, devices, and systems of the disclosed system and method may further verify the behavior of the driver so as to prevent erroneous information from entering its available spot database. Once it is confirmed, or during the confirmation process, other users of the disclosed system and method may receive notifications as according to the description provided above. Similarly, a home listing may require various features, physical or otherwise, to be shared via the disclosed system and method in order for users of the disclosed system and method to be notified both of the home's location and those features.

In other select embodiments, a user's membership in or belonging to a variety of credentialed user networks including but not limited to social networks, customer loyalty and rewards programs, payment processing and credit card customer networks, university and education enrollment management systems, private or secret club membership programs, employee networks, transportation program networks such as rail and bus systems, volunteer membership networks, political party registration, fraternal organizations, the like and/or combinations thereof may be important to the disclosed system and method. Rewarding members for being in such a group may encourage loyalty to the disclosed system and method in conjunction with the group through the private sharing of parking information privately among the user group over another way to communicate about parking, thereby increasing the amount of information contained within, and thereby the value and utility of, the disclosed system and method. It is contemplated that this may be especially important in target areas for parking where many users may desire parking or for parking target areas experiencing significant uptick in parking demand, and the ability for users to prefer with whom they share this valuable data may be an important feature for users. Furthering this utility may be the provision of loyalty vouchers, discount vouchers, loyalty rewards points, the like and/or combinations thereof in exchange for the user provision of information about parking at or near a physical store. In such an embodiment, a user alerting a system and method for facilitating real-time sharing of location of available parking may be prompted or otherwise allowed to choose among a variety of organizations or networks which they possess credentials for before, during, or after step 501, when a user installs an application of the disclosed system and method. These memberships and/or groups may be integrated through means known by those skilled in the art and may be integrated into their installed version of the disclosed application of the system and method. Then, for instance, a customer that has designated at step 611 that they will be driving to a popular destination to shop at their favorite store. At step 622 and step 623, via an application of the disclosed system and method, another customer leaving the same store if both share membership in the store's customer loyalty program may be notified via a notification on said application on a user device. This may be accomplished by a user prompt for prompting a user at step 623, automatic triage based on a user or automatic priority or preference indication, or through any other means by which a user or a system may prioritize who among a larger group may first receive a notification about a parking space vacancy.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A method for facilitating sharing a point of interest information among a plurality of users each having one of a plurality of user computing devices near an at least one target area, the method comprising the steps of:
storing, on a first at least one computer readable medium of an at least one server having a connection to an internet, a master point of interest data associated with a plurality of areas, said master point of interest data comprising a parking size data, a parking cost data, a photographic data, a location data, a parking availability data, a point of interest data, and a home listing data, said plurality of areas each having a plurality of points of interest;
receiving, from an at least one user from the plurality of users via the internet, a request to modify said master point of interest data via a user computing device connected to said internet, said user computing device having a display, a processor, a camera, a location sensor, a connection to the internet, and a second at least one computer readable medium, said second at least one computer readable medium having installed thereon a first operating system with a graphical user interface capable of being displayed on said display;
establishing a connection therebetween said at least one server and said user computing device over the internet;
transmitting from said user computing device to said at least one server, a point of interest information in relation to an at least one point of interest of said plurality of points of interest at the target area, said point of interest information comprising at least a vehicle size information, a parking spot cost information, a geolocation data, a parking spot availability information, and a home listing information;
at a primary stage, evaluating whether said master point of interest data contains an existing entry related to said point of interest; and
at a secondary stage, if said master point of interest data contains said existing entry related to said point of interest, updating said master point of interest data with an updated entry related to said point of interest and if said master point of interest data contains no entry related to said point of interest, creating a new entry related to said point of interest.

2. The method of claim 1, wherein an at least one second user at an at least one second user computing device having a second display, a second processor, a second camera, a second location sensor, and a third at least one computer readable medium, said third at least one computer readable medium having installed thereon a second operating system with a second graphical user interface capable of being displayed on said second display, is provided the location information of an available parking spot and further provided a navigation instruction thereto displayed on said at least one second user computing device.

3. The method of claim 1, wherein said point of interest information in relation to said point of interest is transmitted to said at least one server upon an event from a group of events consisting of a pairing of said user computing device with a vehicle, a connection loss therebetween said user computing device and said vehicle, a connection between said user computing device with a local wireless network, and an arrival of said user computing device at the target area.

4. The method of claim 1, further comprising the step of prompting a user to transmit from said user computing device to said at least one server said point of interest information upon arrival at the target area.

5. The method of claim 4, wherein the said parking spot information further comprises a point of interest photograph information containing an image.

6. The method of claim 4, wherein the target area is a location of said user computing device and the target area has been set as a destination by a second user from said plurality of users having a second computing device travelling to the target area.

7. The method of claim 1, further comprising the step of rewarding said at least one user with a reward from a group of rewards consisting of a loyalty voucher for a physical store, a social media virtual credit, and at least one loyalty point in a customer rewards program.

8. The method of claim 1, wherein said at least one user from said plurality of users belongs to a group, said group having an access credential for said at least one user.

9. The method of claim 8, further comprising the step of transmitting privately said point of interest information among those of said plurality of users having said access credential for said group.

10. The method of claim 1, further comprising the step of transmitting privately said parking spot information between and at least two users of said plurality of users.

11. A parking location information sharing system for sharing parking availability information among a plurality of user devices arriving at a target area via an internet, the system comprising:
a first computing device having a connection to the internet and capable of storing on a first at least one computer readable medium a master parking data associated with a plurality of parking areas, said master parking data comprising a parking size data, a parking cost data, a photographic data, a location data, and a parking availability data, said parking areas having a plurality of parking spots
a plurality of user computing devices each having a processor, a GPS sensor, a wireless network card, a display, a camera and a memory, each of said plurality of user computing devices including a computer program code enabling access to said master parking data via an internet, the memory and the computer program code configured to, with the processor, cause the system to update said master parking data;
wherein a plurality of users, each having one of said plurality of user devices, receives, upon entering a destination into a mobile application for receiving driving directions, a list of available parking spaces within one of said plurality of parking areas and can reserve a parking space within said list of available parking spaces via the mobile application.

12. The parking location information sharing system of claim 11, wherein said master parking data is updated upon a user transmission of, via a user computing device among said plurality of user computing devices, a parking information said parking information comprising a parking size information, a parking cost information, a parking photograph, a parking location information, and a parking availability information.

13. The parking location information sharing system of claim 12, wherein said list of available parking spaces is updated upon said user transmission.

14. The parking location information sharing system of claim 11, wherein said plurality of user computing devices each further comprise a capability to create a wireless connection to a vehicle.

15. The parking location information sharing system of claim 14, wherein said list of available parking spaces is updated with a new available parking space upon an establishment of said wireless connection to said vehicle corresponding to a location of a user computing device from said plurality of user computing devices upon said wireless connection.

16. The parking location information sharing system of claim 15, wherein said plurality of user computing devices are notified of said location.

17. The parking location information sharing system of claim 16, wherein a second user can reserve on a second user computing device from said plurality of user computing devices a parking space corresponding to said location.

18. The parking location information sharing system of claim 17, wherein upon said second user having reserved said parking space, said list of available parking spaces is updated to remove said parking space.

19. The parking location information sharing system of claim 12, wherein the plurality of users further comprises a first group of users and a second group of users.

20. The parking location information sharing system of claim 19, wherein a user in said first group of users is capable of sharing said parking information only among said first group of users.
